(19) United States
(12) Patent Application Publication
(10) Pub. No.: US 2016/0032105 A1
(43) Pub. Date: Feb. 4, 2016

(54) BLUE COLORANT AND METHOD OF MAKING THEREOF

(71) Applicants: Vishal Menon, Tripunithura (IN); Aju Jacob, Kolencherry (IN); Manju Rajesh Nair, Perumbavoor (IN); Chamarthi K. Srikanth, Kothapeta (IN); Mily Mol Mathew, Kolencherry (IN)

(72) Inventors: Vishal Menon, Tripunithura (IN); Aju Jacob, Kolencherry (IN); Manju Rajesh Nair, Perumbavoor (IN); Chamarthi K. Srikanth, Kothapeta (IN); Mily Mol Mathew, Kolencherry (IN)

(21) Appl. No.: 14/257,625

(22) Filed: Apr. 21, 2014

(51) Int. Cl. C09B 61/00

(52) U.S. Cl. CPC C09B 61/00

(57) ABSTRACT

A blue colorant of the formula

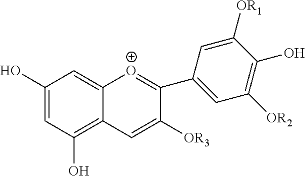

is provided where R1 and R2 are formed by the combination of cinnamic acid and glucose and R3 is malonyl glycoside. When used as blue colorant in food, the blue colorant provides stable blue shade at low pH levels and possesses good heat and light stability.

### FIELD OF THE DISCLOSURE

The present disclosure relates to composition of natural blue colorant suitable for use in food products and methods of producing such natural blue colorants.

### BACKGROUND

Colorants in foods are either natural pigments or synthetic dyes or lakes. Since the number of synthetic colors is limited, there is a need to further explore natural pigments as colorants. More specifically, there is extensive research in finding suitable natural blue pigments as color additives.

The present disclosure relates in particular to a blue anthocyanin colorant obtained by extraction from tropical herb Clitoria ternatea (L). While blue colorants are well known, conventional blue colorants do not provide stable blue shade at low pH and do not provide good heat and light stability. For instance, almost all conventional blue colorants give purple to red shade at pH 3 to pH 7. Some blue colorants will also change color under the light or at different temperature.

Accordingly, there exists a need for improved blue colorants which not only provide stable blue shade at low pH levels but also possess good heat and light stability.

### SUMMARY OF THE INVENTION

The present inventors have made continuous efforts to develop a novel blue colorant composition with improved characteristics such as providing stable blue shade at low pH levels and possessing good heat and light stability.

It is, therefore, an object of the present disclosure to provide a blue colorant composition which comprises a structural formula:

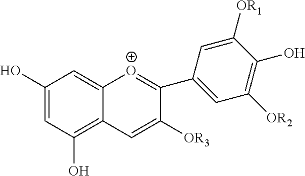

where R1 and R2 are formed by the combination of cinnamic acid and glucose and R3 is malonyl glycoside.

Since the blue colorants of the present disclosure provides stable blue shade at low pH and possess good heat and light stability, it is very suitable as food additive because a lot of food have pH level between 3-7 and require heating.

These and other features, aspects and advantages of the present disclosure will become better understood with reference to the following drawings, description and claims.

### BRIEF DESCRIPTION OF THE DRAWINGS

FIG. 1 is a diagram showing an exemplary embodiment of the present invention.

### DETAILED DESCRIPTION OF THE INVENTION

The following description is not to be taken in a limiting sense, but is made merely for the purpose of illustrating the general principles of the disclosure. Various inventive features are described below that can each be used independently of one another or in combination with other features.

Anthocyanins (E163) from plants are permitted as food colorants all over the world. Floral anthocyanins from Clitorea Ternatea (CT) are legitimate food colorants. Given its historical and continuous use as a food ingredient in a large part of the world, CT can be a viable source of anthocyanins; and the extract meets the specific purity criteria as per EU standards.

Broadly, embodiments of the present disclosure generally provide a blue colorant represented by the structure formula:

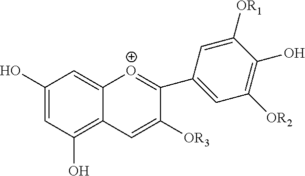

where R1 and R2 are formed by the combination of cinnamic acid and glucose and R3 is malonyl glycoside. The cinnamic acid can be represented by structural formula:

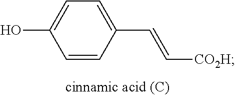 [SMILES: O=C(O)/C=C/c1ccc(O)cc1]

the glucose can be represented by structural formula:

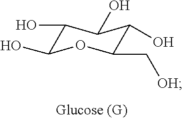 [SMILES: OCC1OC(O)C(O)C(O)C1O]

And the malonyl glycoside can be represented by structural formula:

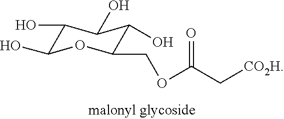 [SMILES: O=C(O)CC(=O)OCC1OC(O)C(O)C(O)C1O]

In yet another embodiment of the present disclosure, R1 and R2 can be further represented by the structural formulas as shown in Table 1 below:

TABLE 1

| | | NAME OF THE |
|---|---|---|
| R1 | R2 | STRUCTURE |
| GCGCG | GCGCG | DELPHIDIN 3-MALONYL |
| | | GLYCOSIDE 3′-GCGCG 5′- |
| | | GCGCG |
| GCGCG | GCG | DELPHIDIN 3-MALONYL |
| | | GLYCOSIDE 3′-GCGCG 5′- |
| | | GCG |
| GCGC | GCG | DELPHIDIN 3-MALONYL |
| | | GLYCOSIDE 3′-GCGC 5′- |
| | | GCG |
| GCGC | GC | DELPHIDIN 3-MALONYL |
| | | GLYCOSIDE 3′-GCGC 5′- |
| | | GC |
| GCGC | G | DELPHIDIN 3-MALONYL |
| | | GLYCOSIDE 3′-GCGC 5′-G |
| GCG | GCG | DELPHIDIN 3-MALONYL |
| | | GLYCOSIDE 3′-GCG 5′- |
| | | GCG |
| GCG | GC | DELPHIDIN 3-MALONYL |
| | | GLYCOSIDE 3′-GCG 5′-GC |
| GCGC | GCGC | DELPHIDIN 3-MALONYL |
| | | GLYCOSIDE 3′-GCGC 5′- |
| | | GCGC |
| GC | GC | DELPHIDIN 3-MALONYL |
| | | GLYCOSIDE 3′-GC 5′-GC |
| GC | G | DELPHIDIN 3-MALONYL |
| | | GLYCOSIDE 3′-GC 5′-G |

For example, the blue colorant of the present disclosure can be fully represented by structural formula:

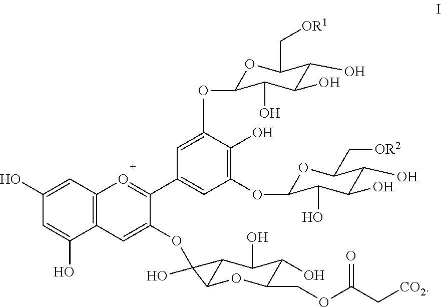

The blue colorant of the present disclosure is an anthocyanin which is extracted from tropical herb Clitoria ternatea. In one of the embodiment of the present disclosure, the process of extracting the blue colorant from Clitoria ternatea is provided. The process comprises a) Contacting freeze dried flowers with aqueous ethanol having specific gravity less than 0.96. at a temperature not exceeding 50-60 degree Celsius; b) Removing the solvent from the spent of flowers; c) Removing the undissolved solids from the extraction solvent; d) Removing the solvent at low temperatures to get the extract; e) Dissolving the said concentrate of anthocyanin in aqueous solvent for complete dissolution; f) Contacting the said solution with a non-ionic adsorbent to adsorb the said anthocyanins; g) Separating said adsorbate and said adsorbent with water; h) Separating the enriched anthocyanin from aqueous solvent; i) Subjecting the enriched anthocyanin to Combiflash for further purification; j) Separating the said enriched anthocyanin from solvent; k) Performing confirmative analyses with UV, HPLC, IR and NMR; l) Confirming the color hue with colorimeter; and m) Studying the stability with respect to pH, light and heat.

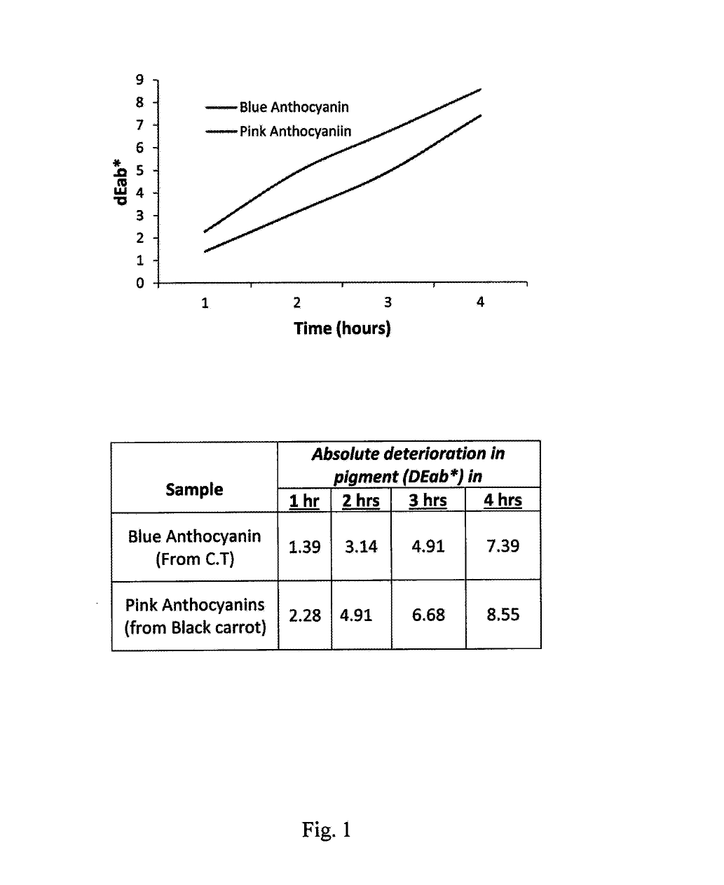

As shown in FIG. 1, blue colorant of present disclosure is more stable towards light when compared to pink anthocyanins during stability test.

In yet another aspect of at least one embodiment of the present disclosure, the blue colorant can be blended with other natural pigments to obtain different color shades. The blue colorant of the present disclosure is also safe to consume and, not by way of limitation, can be applied to dairy, confectionary, alcoholic beverages, functional ingredients such as such as ice-cream, yogurt, flavored milk, beverage, pan coated tablets, cookies and jellies. The blue colorant of the present disclosure can further be used on pharmaceutical products, pet food, cosmetic, candle, textiles and child-safe paints.

In yet another embodiment of the present disclosure, the blue anthocyanin colorant is formulated with emulsifiers with HLB values of 8 to 16.

Among other things, the present disclosure provides various benefits and advantages to the food industry. One benefit of the blue colorant of the present disclosure is that it provides stable blue shade at low pH and also provides good heat and light stability.

It should be understood, of course, that the foregoing relates to exemplary embodiments of the disclosure and that modifications may be made without departing from the spirit and scope of the disclosure as set forth in the following claims.

What is claimed is:

1. A method for producing nature blue anthocyanin colorant from Clitoria ternatea comprising:
contacting freeze dried/blast freezed flowers of Clitoria ternatea with aqueous ethanol, iso propyl alcohol, water, acetone and ethyl acetate and their combinations diluting the aqueous ethanol from spent of the freeze dried flowers;
removing undissolved solids from the aqueous ethanol;
removing the aqueous ethanol to obtain anthocyanin extract;
dissolving anthocyanin extract in aqueous solvent for complete dissolution;
contacting aqueous solvent with a non-ionic adsorbent to adsorb the anthocyanins;
separating non-ionic adsorbent with water; and
separating the anthocyanins from the aqueous solvent.

2. The method of claim 1, further comprises subjecting the anthocyanin to Combiflash for further purification.

3. The method of claim 1, further comprises performing confirmative analyses with UV, HPLC, IR and NMR.

4. The method of claim 1, further comprises confirming the color hue with colorimeter.

5. The method of claim 1, further comprises performing stability studies with respect to pH, light and heat of the blue anthocyanin colorant.

6. The method of claim 1, wherein the aqueous ethanol has specific gravity less than 0.96 at a temperature not exceeding 50-60 degree Celsius.

7. The method of claim 1, further comprises formulating the anthocyanin with emulsifiers with HLB values 8-16.

8. The method of claim 1, wherein the aqueous ethanol has specific gravity less than 0.96 at a temperature not exceeding 50-60 degree Celsius.

9. A composition represented by the following structural formula: 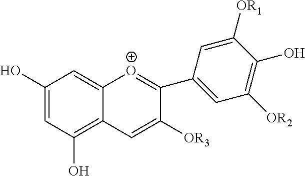
wherein R1 and R2 are formed by the combination of cinnamic acid and glucose; and
wherein R3 is malonyl glycoside.

10. A composition according to claim 9, wherein the cinnamic acid is represented by

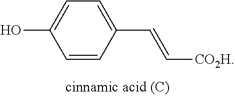 [SMILES: O=C(O)/C=C/c1ccc(O)cc1]

11. A composition according to claim 9, wherein the glucose is represented by

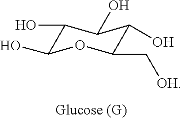 [SMILES: OCC1OC(O)C(O)C(O)C1O]

12. A composition according to claim 9, wherein the malonyl glycoside is represented by

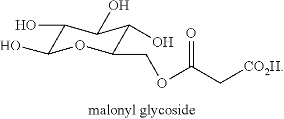 [SMILES: O=C(O)CC(=O)OCC1OC(O)C(O)C(O)C1O]

13. The composition of claim 9, wherein the composition is formulated with emulsifiers with HLB values of 8 to 16.

14. A composition represented by the following structural formula:

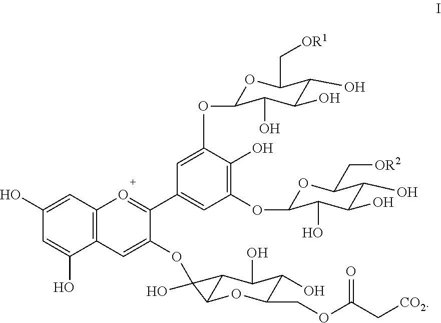

15. The composition of claim 14, wherein the composition is formulated with emulsifiers with HLB values of 8 to 16.
